(19) United States
(12) Patent Application Publication
(10) Pub. No.: US 2013/0206454 A1
(43) Pub. Date: Aug. 15, 2013

(54) ELECTRODE FOR MEDICAL APPLICATIONS, SYSTEM HAVING SUCH AN ELECTRODE, AND METHOD FOR PRODUCING SUCH AN ELECTRODE

(71) Applicants: Giorgio Cattaneo, Karlsruhe (DE); Alfred Stett, Reutlingen (DE); A. Gharabaghi, Tuebingen (DE)

(72) Inventors: Giorgio Cattaneo, Karlsruhe (DE); Alfred Stett, Reutlingen (DE); A. Gharabaghi, Tuebingen (DE)

(73) Assignee: ACANDIS GMBH & CO. KG, Pfinztal (DE)

(21) Appl. No.: 13/818,662

(22) PCT Filed: Aug. 26, 2011
(86) PCT No.: PCT/EP2011/004307

§ 371 Date: May 3, 2013

(30) Foreign Application Priority Data
Aug. 26, 2010 (DE) 10 2010 035 475.9

(51) Int. Cl. H01B 5/00

(52) U.S. Cl. CPC H01B 5/00
USPC 174/126.1

(57) ABSTRACT

An electrode for intravascular medical applications for neuromodulation and/or nerve stimulation and/or neurological signal detection, wherein the electrode can be compressed and expanded in order to insert same into a hollow organ of a body and is or can be coupled to a current supply. A compressible and expandable lattice structure is provided, which has cells formed from lattice webs and is or can be coupled to the current supply, the lattice structure being obtained at least partially by physical vapor deposition.

The invention relates to an electrode for medical applications for neuromodulation and/or nerve stimulation and/or neurological signal acquisition, which is compressible and expandable for introduction into a hollow organ of a body and is coupled or couplable to an electrical supply. An electrode of this type is known, for example, from U.S. Pat. No. 5,531,779.

The known electrode is used for the treatment of heart defects, and is configured for the transmission of relatively strong currents which are necessary for such treatments. The electrode is formed as an intravascular stent, which is produced from a steel alloy and is conductive overall. The stent as a whole therefore forms the probe, which is compressible and expandable for introduction into the body. In order to generate an electric field, the stent electrode is combined with a further electrode, which is for example configured in the form of a second stent electrode, which is implanted at a distance from the first stent electrode.

The known stent electrode is constructed from individual wires, which extend essentially parallel in the expanded state and are formed in the manner of a basket. Other stent structures based on wires, for example woven or meshed stents, are disclosed as suitable. Stents configured in such a way are in practice produced with the aid of meshing machines, a plurality of wires being combined to form a cylindrical mesh.

From practice, stents are generally known which are produced from a tubular solid material by a material removal method, for example a laser cutting method. Both the known wire-meshed and the laser-cut structures have nonuniform or irregular electrical properties. For low currents or voltages, the known structures, in particular the electrode according to U.S. Pat. No. 5,531,779, are therefore poorly suited. The production of a plurality of electrodes with identical or similar electrical properties is made more difficult since the materials used have locally different conductivities.

An electrode which is used for heart treatment is known from US 2003/74039 A1. The electrode is used with a further additional electrode, in order to generate an electric field.

Electrodes are furthermore known in which the electrode poles are integrated into the same implantable body, so that the second separate electrode can be obviated. For example, U.S. Pat. No. 6,445,983 B1 discloses a stent electrode, on the outer surface of which a first electrode and a second electrode, by which a radio signal can be driven, are fastened. Another example of an implantable electrode, in which the two poles are arranged in the same implant, is known from WO 2008/09434 A1, which discloses a spirally shaped wire on which different electrode regions, or poles, are provided. The various electrode regions can be driven independently of one another, so that the electric field generatable with the electrode is modulatable.

A similar electrode is known from WO 2008/094789 A1, which has a stent structure for anchoring the electrode wire. This stent structure is connected to the electrode wire so that the electrode wire is pressed onto the vessel wall by expansion of the carrier stent. The stent is in this case used exclusively as a mechanical support.

Another electrode consisting of a wire comprising different polarizable electrode regions is known from EP 1 304 135 A2.

Production of the aforementioned electrodes is complicated, since either elaborate joining techniques are required therefor or the electrical supply of the individual electrode regions is difficult to produce. Furthermore, the electrodes connected to the support structure are comparatively large, so that on the one hand the number of electrodes is restricted and, on the other hand, precise adjustment of the electric fields is only limitedly possible. Furthermore some of the known systems require lines which are connected to the electrode and must correspondingly be insulated, since otherwise contact with the supporting structure of the electrode would lead to a short circuit. The insulated lines increase the complexity and unwieldiness of the systems and make delivery more difficult, particularly into small vessels. Furthermore, irregular surfaces may arise, so that the risk of injury increases. The disadvantage of conventional electrodes also consists in the difficulty of accommodating many circuits on one electrode.

In the conventional production of wires for known electrodes by melting technology, relatively large inclusions are unavoidably formed in the material structure. These inclusions are formed in the melt, grow when the melt is cooled and are then present in the solidified material. The inclusions caused by melting technology may, for example in the case of nickel/titanium alloys, contain titanium, nickel as well as carbon and/or oxygen. The size of the inclusions is in practice a few μm, in particular from 5 μm to more than 20 μm.

In the scope of the application, inclusions are intended to mean phases, formed by melting technology, in which there are extraneous elements, for example carbon and/or oxygen, in addition to titanium and nickel. These extraneous elements may be present in the raw material or introduced externally into the material, for example by the crucible or the melting process. In the case of conventionally produced material, in addition to the inclusions, precipitates (precipitations) of phases from the solid solution may also occur during the heat treatment, and these may grow as a result of multiple annealing treatments and/or forming of the material.

Overall, precipitates are distinguished from inclusions at least by their origin. Precipitates are formed as a phase from the solid solution, i.e. from the crystalline material. In other words, precipitates are precipitated from the crystalline material. Inclusions, on the other hand, are formed in the melt by seed growth with extraneous atoms and remain existing, or included, in the solidified material.

In summary, undefinedly many lattice defects, which are not controllable, are induced in conventionally produced electrodes owing to the multiplicity of successive processes (melting and solidification, a plurality of hot forming and cold forming operations with intermediate heat treatments, in particular intermediate anneals, between them). These lattice defects interact with one another. For example, the density of the vacancies influences the dislocation formation and the dislocation movement. The cold deformation is a significant cause of dislocation formation and, together with the annealing treatments, also greatly influences the grain size. Consequently, for a conventionally produced component, it is possible neither to accurately predict or adjust the electrical resistance nor can batch differences or lot-to-lot differences be avoided.

It is an object of the invention to provide an electrode for intravascular medical applications, which has improved electrical properties. The invention is furthermore intended to provide a system having such an electrode and a method for producing such an electrode.

According to the invention, the object is achieved in relation to the electrode by the subject-matter of patent claim 1, or alternatively by the subject-matters of co-ordinated claims 28, 30, in relation to the system by the subject-matter of patent claim 24, and in relation to the method by the subject-matter of patent claim 26.

The invention is based on the concept of providing an electrode for medical applications for neuromodulation and/or nerve stimulation and/or neurological signal acquisition. The electrode is compressible and expandable for introduction into a hollow organ of a body. The electrode is furthermore coupled or couplable to an electrical supply. The electrode comprises a compressible and expandable lattice structure which has cells formed by lattice webs. The lattice structure is coupled or couplable to the electrical supply. The lattice structure is in this case obtained at least in particular layer-wise partially by physical vapor deposition.

The electrode according to the invention differs from the known systems, in particular from the system according to U.S. Pat. No. 5,531,779, on the one hand in that the lattice structure is formed from lattice webs. The lattice webs form, or delimit, cells. The lattice structure according to the invention is thus not a lattice structure based on individual wires, as in the case of a mesh or weave, but a lattice structure based on lattice webs. The lattice webs are in this case preferably arranged flush with one another in the same wall plane, that is to say in a single wall plane. Furthermore, in contrast to individual wires, the lattice webs are connected solidly to one another at intersection points, in particular connected with a material fit.

On the other hand, the electrode according to the invention differs from known electrodes in that the lattice structure is obtained at least partially, in particular layer-wise, by physical vapor deposition (PVD). As lattice structures, the known electrodes have meshes in which the wires are conversely produced by metallurgical melting and by deformation. The same applies for laser-cut lattice structures. This leads to identifiable differences between the structure of the electrode according to the invention and the structure of known electrodes. In known electrodes, for example, a stretched or rolled texture is formed by the forming step during production, which is not present in the structure of the electrode according to the invention owing to the PVD production. Furthermore, the electrode according to the invention differs from known electrodes by the lack of elongation of the precipitates. In known electrodes, the precipitates are anisotropic, the precipitates essentially being oriented in the deformation direction because, for example, pseudoelastic shape memory materials are specifically processed directionally, in particular tubes or wires. This is achieved by a heat treatment under stress. In the case of the electrode according to the invention, the precipitates are essentially isotropic. In general, the structure of the electrode according to the invention is essentially isotropic or at least more isotropic than the structure of the known electrodes, which is essentially anisotropic. Further differences are to be found in the uniformity and size of the precipitates.

A particularly significant difference consists in the presence or size of inclusions. In the electrode according to the invention, there are generally no inclusions in the structure. If inclusions are present, the size of these inclusions is less than the size of inclusions in electrodes produced by metallurgical melting. In conventional electrode materials, there are inclusions in the form of carbides and/or intermetallic phases with oxygen. The electrode according to the invention therefore differs per se from known electrodes. Owing to the plastic deformation during the production of conventional electrodes, the structure around the inclusions is perturbed, which affects the conductivity of the electrode. Since there are no inclusions, or only relatively small inclusions, in the material in the case of the electrode according to the invention, the structure is not perturbed, or is perturbed only relatively little, when the material is deformed. This has a positive effect on the conductivity.

In the scope of the invention, the entire lattice structure may be produced by a PVD method. A self-supporting lattice structure can thereby be obtained. As an alternative, on a carrier structure which is not produced by a PVD method, in particular on a conventional carrier structure, a layer having a different function to the carrier layer may be applied by a PVD method. When the material properties of the lattice structure are explained in more detail below, the comments relate both to the case in which only a part or a region of the lattice structure, for example the layer or individual lattice elements, have the material properties, and to the case in which the entire lattice structure, for example in the case of a self-supporting lattice structure, has the material properties.

A region of the lattice structure may on the one hand refer to at least one layer of a lattice element, which is delimited in the radial direction or thickness direction, and thus forms a distinguishable material region (layer region). A region of the lattice structure may on the other hand refer to a part of the wall, which is formed by the lattice structure, i.e. to a region (wall region) extending perpendicularly to the thickness direction. For example, a region of the lattice structure may comprise individual lattice elements, in particular lattice webs or parts thereof, or one or more cells of the lattice structure. A combination of the layer regions and the wall regions is possible.

Owing to the precise controllability of the method parameters during physical vapor deposition, for example the temperature and/or the distance from the target, structural properties can be adjusted accurately. Physical vapor deposition furthermore allows repeatable production of the lattice structure with the same properties. The special structural properties, or material properties, of the electrode according to the invention lead to an improvement in the electrical properties, in particular the conductivity, of the lattice structure. The electrode according to the invention is therefore suitable not exclusively, but particularly, for neurological applications, particularly in the field of sensor technology.

The conductivity of the lattice structure, or of the electrode, is intended to mean on the one hand the conductivity of the electrode surface coming in contact with the tissue, in particular the outer surface, in order to transmit electrical pulses from the electrode into the tissue, or in order to receive electrical signals from the tissue without loss and forward them via the electrode body as a mechanical support to the evaluation. On the other hand, the conductivity of the lattice structure, or of the electrode, is also intended to mean the conductivity in the electrode, i.e. the conductivity of a material which fulfills the function of carrying current in the electrode. The conductivity of this material may be higher than the conductivity of the carrier material of the lattice structure, for example higher than the conductivity of materials based on NiTi.

The effect achieved by producing the electrode using the PVD method is that relatively constant or uniform electrical properties are set up over the entire lattice structure, whereby these properties can furthermore be controlled deliberately during production of the lattice structure. The electrode according to the invention therefore makes it possible to generate an essentially homogeneous electric field. By virtue of the PVD method, it is also possible to vary the electrical properties of the electrode along the lattice structure, which is not possible in the case of conventional electrodes. At the same time, by the structural properties achievable by physical vapor deposition, good stability of the lattice structure is achieved so that the lattice structure, or in general the electrode, is suitable for supporting a hollow body organ. In particular, physical vapor deposition makes it possible to produce a self-supporting electrode. The electrode according to the invention has both good mechanical properties and good electrical properties.

In contrast to the conventional electrodes produced by melting technology, by the thin-film method of physical vapor deposition a material is provided which has no inclusions, or at least a reduced number of inclusions. The material of the lattice structure of the electrode according to the invention is thus essentially free of inclusions at least locally, particularly throughout the region of the lattice structure, since the material is produced not directly from a melt but by depositing an atomized target material on a substrate. The local adjustment of the material properties is achieved by producing one or more regions by a PVD method. It is assumed that the oxygen and carbon contents achievable by physical vapor deposition are lower than in the case of materials conventionally produced by means of melting technology, since physical vapor deposition is carried out in a vacuum.

If inclusions nevertheless occur because of impurities during the production of the material of the lattice structure by the physical vapor deposition method, these are substantially smaller in the case of the lattice structure of the electrode according to the invention than in the case of lattice structures which are produced by conventional melting methods. The inclusions in the material of the lattice structure amount to at most 1 μm, in particular at most 500 nm, in particular at most 200 nm, in particular at most 100 nm, in particular at most 75 nm, in particular at most 50 nm, in particular at most 25 nm.

In principle, through the presence of inclusions, the uniformity, size and elongation of precipitates, and the presence of a stretched or rolled texture, it is possible to identify whether an electrode or lattice structure has been produced conventionally or by means of vapor deposition.

Precipitates in the material of the lattice structure of the electrode according to the invention consist of the alloy components and usually do not contain any externally introduced extraneous atoms. For example, precipitates in the case of materials made of nickel/titanium alloys generally consist of titanium and nickel, there being various precipitate types with different compositions. Typical precipitates which may be encountered with physical vapor deposition comprise Ni₄Ti₃.

Another difference which makes the different production methods identifiable on the material is that the inclusions and the precipitates in the case of materials processed conventionally by melting technology, or processed conventionally, are arranged in an elongated form in the stretching direction (tube or wire) or the rolling direction (sheet metal). Conversely, the precipitates of the lattice structure material according to the invention are oriented isotropically. The isotropic, i.e. non-directional orientation of the precipitates has a positive effect on the electrical properties, in particular the conductivity and/or the homogeneity of the conductivity and/or the adjustability of the conductivity of the electrode. Furthermore, all conventionally produced structures contain forming textures, that is to say rolling or stretching textures with a preferential direction of the crystallites.

Compared with the known electrodes which are produced by means of melting technology, the electrode according to the invention, which is produced by a physical vapor deposition method, locally has less carbon constituents and less oxygen constituents than conventional material. Lattice structure defects can be controlled better in the case of the material produced by physical vapor deposition. The hot forming steps associated with conventional production, up to 50 or more cold forming operations and intermediate annealing processes, and the uncontrollable lattice defect states resulting therefrom, are avoided. The same applies for the size of grain boundaries inside the material, which can likewise be controlled better by the production method provided according to the invention. The homogeneity of all lattice structure defects influencing the electrical properties is substantially better than in the case of conventionally produced material. The reason for this is that, after melting the starting material (for example NiTi), only the physical vapor deposition and (optionally) a single annealing treatment are subsequently carried out. The variation range of the density of vacancies, dislocations or grain boundaries of the material cross section is low. Inclusions are avoided.

Preferably, the material of the lattice structure has at least locally a maximum density of material inhomogeneities, such as lattice structure defects, adjusted in a controlled way by physical vapor deposition. The material of the lattice structure may also, in particular additionally, have a maximum density of interfacial defects and/or bulk defects which is adjusted in a controlled way. The material of the lattice structure thereby differs further from electrodes produced conventionally from solid material, for example by forming, which have a greater density of material inhomogeneities than material produced by physical vapor deposition. Defects in the structure of the material, i.e. material inhomogeneities, such as lattice structural defects (for example vacancies, interstitial atoms, step dislocation, screw dislocation, stacking defects) and/or interfacial defects and/or bulk defects, hinder the charge transport and reduce the conductivity. Therefore, a uniform conductivity of the lattice structure, or in general the electrode, which is advantageous in particular for neurological applications or sensor technology, is achieved by the material inhomogeneity density reduced owing to the physical vapor deposition. The material of the compressible and expandable lattice structure is produced by physical vapor deposition in such a way that the material is sustantially free of deformation textures and/or free of elongation of the precipitates and/or free of inclusions.

In a preferred embodiment of the electrode according to the invention, the average grain size of the material of the lattice structure is at least locally less than 4 μm, in particular less than 3 μm, particularly preferably less than 2 μm, in particular less than 1.5 μm, in particular less than 1 μm, in particular less than 0.5 μm, in particular less than 250 μm. In contrast to conventional electrode materials, these grain sizes can be achieved in a structure without deformation textures. Average grain sizes of conventionally produced materials for electrodes are for instance from 5 μm 20 μm. These are large-angle grain boundaries in the former austenitic grains.

In the electrode material according to the invention, smaller variations in the grain size occur than in the case of conventional material produced by melting technology. This applies both within a component and from lot-to-lot, or batch-to-batch, and within a lot. The grain size is homogeneous, in particular more homogeneous than in the case of material produced by melting technology. Owing to the homogeneous average grain size, a uniform and controllable conductivity of the material of the lattice structure is achieved.

In order to influence or adjust the size of the precipitates and/or the density of inhomogeneities, in particular linear lattice structure defects and/or interfacial defects and/or bulk defects, it is advantageous to produce the lattice structure at least partially by sputtering or by laser-assisted deposition. By varying individual process parameters of the vapor deposition method, the inhomogeneities in the material of the electrode can be adjusted in a controlled way. Process variables suitable therefor are, for example, the chamber pressure in the process chamber and/or the deposition pressure and/or the partial pressure of the process gas and/or the target composition.

By varying such parameters, in a manner known per se the size of the precipitates or lattice structure defects and the density thereof can be adjusted in a controlled way. Furthermore, the grain size can be adjusted in a controlled way. The deliberately adjusted inhomogeneities or lattice structure defects, in general the structural properties, can be monitored by electron microscopy test method, in particular with the use of a scanning electron microscope or a transmission electron microscope. The quality and quantity of the measured or determined lattice structure defects can be used in order to adjust the process parameters of the vapor deposition method.

The metal of the lattice structure preferably comprises a shape memory alloy based on NiTi (X) or steel or a chromium/cobalt alloy or a biologically degradable material. Combinations of aforementioned materials are likewise possible.

The use of shape memory materials has proven advantageous particularly in medical technology. Production of the component, in this case the lattice structure, from a shape memory is carried out by physical vapor deposition. The lattice structure produced by vapor deposition from a shape memory alloy has advantages in comparison with conventionally produced shape memory components. In the case of conventional shape memory components, the production is carried out by vacuum melting, hot forming, cold forming, optionally laser cutting, erosion or other methods of processing and final shaping. In the scope of structural conversions, bulk defects occur in this case, for example lattice vacancies and large inclusions, which are not controllable by method of technology.

In general, the material of the lattice structure of the electrode fulfills a double function. On the one hand, the material of the lattice structure influences the mechanical properties, in particular the stability and flexibility of the electrode. On the other hand, the material of the lattice structure is crucially involved in the quality of the electrical properties, in particular the conductivity of the electrode. The double function of the material of the lattice structure is improved by the use of a shape memory alloy both in respect of the mechanical properties and in respect of the electrical properties. In particular, owing to the pseudoelastic effect of the shape memory material, the lattice structure has good mechanical properties, particularly in terms of flexibility. The lattice structure is generally self-expandable. In principle, the widening can be induced by the temperature-controlled shape memory effect. Mechanically expandable, in particular balloon-expandable, lattice structures are possible.

For the electrode, an improvement of the fatigue behavior of the lattice structure is to be expected, which is expedient particularly in terms of the expansion function of the lattice structure. A shape memory material which comprises a nickel/titanium alloy has proven particularly advantageous, the nickel/titanium alloy advantageously having a composition of 50.8 atom % nickel and 49.2 atom % titanium.

In addition or as an alternative to a shape memory alloy, the lattice structure may comprise a biologically degradable material. Suitable biologically degradable materials may, for example, comprise magnesium and/or calcium, and/or zinc. Biodegradable polymers may also be envisioned. With a biologically degradable material, it is possible to produce an electrode which is suitable for temporary use in a hollow body organ. Specifically, the electrode may be introduced into a hollow body organ and used to deliver or acquire electrical signals, the function of the electrode being time-limited. The electrode is biologically degraded, so that a time-limited treatment is made possible, with a further operative intervention to remove the electrode being avoided. Additional or further operation-related health risks are therefore avoided. It is also possible to produce only the carrier from biologically degradable material, so that after the electrode, or the electrically activated part of the electrode, has grown in, the dissolvable carrier has entirely vanished.

The lattice structure may be formed rotationally symmetrically, in particular hollow-cylindrically, at least in a production state. A production state in the scope of the application refers to the state of the lattice structure in which essentially no external forces that can induce compression act on the lattice structure. In other words, the production state corresponds to a stress-relieved state of the lattice structure. The lattice structure is fully expanded in the production state. In general, the lattice structure may be produced in the manner of a stent. The electrode may be a stent electrode. Owing to the rotationally symmetrical or hollow-cylindrical shape, the lattice structure offers good conditions for implantation or temporary use in hollow body organs, in particular blood vessels.

According to another preferred embodiment, the lattice structure has a plurality of layers, in particular two layers arranged successively in the radial direction, in particular having different functions. The different functions of the layers may, for example, be due to different materials and/or different structural properties for forming the layers. In other words, the lattice structure may comprise different layers, which consist of a different material to one another. This does not, however, exclude the layers comprising the same material. The different layers are preferably arranged on one another in the radial direction. The lattice structure may thus have at least one outer layer which extends over an outer circumference of the lattice structure. In addition, an inner layer may be provided, which extends over an inner circumference of the lattice structure. The two layers, i.e. the outer layer and the inner layer, are therefore arranged concentrically or coaxially in one another. As considered in the radial direction, the two or more layers lie on one another, or are arranged on one another.

The lattice structure may, in particular, have at least one electrically conductive layer and at least one mechanically supporting layer, in particular of different materials. The above-explained double function of the lattice structure, or of the material of the lattice structure, can thus be assigned to different layers. This does not exclude one of the layers additionally comprising the double function, namely improved mechanical and improved electrical properties. For example, alloys based on NiTi are electrically conductive.

In a particularly preferred configuration of the invention, the electrically conductive layer is arranged externally for contact with the hollow organ and the mechanically supporting layer is arranged radially further inward in relation to the electrically conductive layer. In other words, the inner layer is formed as a mechanically supporting layer and the outer layer as an electrically conductive layer. Arranging the electrically conductive layer externally, or on an outer circumference of the lattice structure, is particularly advantageous with a view to efficient electrical contact with a vessel wall of a hollow body organ. During use, the lattice structure is preferably braced on an inner surface of the vessel wall of a hollow body organ, so that good and stable electrical contact is set up between the electrode and the body cavity.

The lattice structure may have at least one X-ray visible layer. The effect advantageously achieved by this is that the positioning of the electrode, or of the lattice structure, in a hollow body organ can be observed from an external standpoint, and therefore monitored. By the improved X-ray visibility of the lattice structure, accurate positioning of the electrode is ensured. Overall, the X-ray visible or fluoroscopically visible layer improves the handleability of the electrode. With the aid of the metals platinum and gold, it is clear that the X-ray visible layer may simultaneously undertake the conductivity.

The electrically conductive layer may furthermore be connected to an electrically insulating layer, in particular an insulator layer. The electrically insulating layer is preferably arranged on a side of the electrically conductive layer arranged radially inward or radially outward. The electrically insulating layer may furthermore be arranged between two layers to which the same or different electrical voltages can be applied. The two layers enclosing the electrically insulating layer may be formed by the outer layer and the inner layer. The two enclosing layers are DC-separated from one another by the electrically insulating layer. Different electrical voltages may be applied to the layers separated by the electrically insulating layer. In particular, a negative voltage may be applied to one of the two layers which are electrically separated by the electrically insulating layer, and a positive voltage may be applied to the other layer. One of the two electrical voltages may be zero. Advantageously, the application to the layers separated by the electrically insulating layer is set by the material properties of the layers. For example, the two layers separated by the electrically insulating layer may have different electrical resistances.

In general form, an electrode is thus disclosed and claimed, the compressible and expandable lattice structure of which is structured layer-wise from lattice webs, at least one layer which is adapted to transmit pulses and receive electrical signals being arranged on the outer surface of the lattice structure.

The lattice structure has at least one further layer which is adapted for carrying current, and the layer arranged on the outer surface of the lattice structure is coupled or adapted for coupling to an electrical supply. The further layer may be arranged on the outer surface of the lattice structure and likewise adapted to transmit pulses and receive electrical signals. The further layer may extend in the lattice structure and therefore fulfill a pure or at least predominant supply function. It is also possible for the further layer for electrical supply to correspond to the mechanically supporting layer. If necessary, the conductive layers are separated by insulating layers.

By the use of thin-film technology in conjunction with the PVD method, it is therefore possible
to set up electrical functions, for example the transmission of pulses and the reception of electrical signals on very small regions of the electrodes, that is to say to fit very many transmitters and/or receivers on the electrode
to use the structure of the lattice structure in order to effect spatial separation between transmitters/receivers, or
to carry out local orientations of the transmitters and/or receiver points
even to fit transmitters and receivers inside a web of the lattice structure

In another preferred embodiment of the electrode according to the invention, the lattice structure is loaded with at least one medicament which can be released or activated by application of an electrical voltage. The local delivery of medicaments or therapeutically effective substances can therefore be controlled as a function of time. For example, this permits continuously time-offset delivery of medicaments, by means of which new therapeutic possibilities are opened up. The time-controlled delivery of medicaments may be controllable in an automated way. For example, in a similar way as with known insulin pumps, medicament delivery may on the one hand take place chronologically at particular times of day. On the other hand, medicament delivery may be manually triggerable. This embodiment of the electrode according to the invention therefore offers an improved possibility for medication adapted to requirements.

The mechanically supporting layer of the lattice structure may be formed from a biologically degradable material. After installation of the lattice structure, or generally the electrode, in a hollow body organ, endothelialization usually takes place, with body tissue encapsulating the lattice webs of the lattice structure. The lattice structure thus grows into the tissue of the hollow body organ. Beyond a certain degree of endothelialization, the carrying or supporting function of the mechanically supporting layer of the lattice structure becomes unimportant, since the lattice structure is stabilized by the body's own tissue of the hollow body organ. By means of the biologically degradable material, the mechanically supporting layer is degraded simultaneously with the endothelialization of the lattice structure. The electrically conductive layer, however, remains and is stabilized sufficiently by the body's own tissue. By the degradation of the mechanically supporting layer, the tissue of the hollow body organ is mechanically relieved of stress so that, particularly in the case of blood vessels, the original compliance, i.e. wall tension or elasticity, of the hollow body organ is at least partially restored. The electrode treatment or the signal acquisition can be continued by using the electrically conductive layer remaining in the vessel.

According to another preferred embodiment, the lattice webs of the lattice structure have an outer layer and an inner layer. The outer layer having a widening which extends in the longitudinal direction of the lattice webs, in such a way that the lattice webs are wider in the region of the outer layer than in the region of the inner layer. Owing to the widening, the area of contact with the body tissue is increased, so that the transmission of electrical signals from the lattice structure into the tissue and vice versa is improved. At the same time, the lattice structure has an improved crimpability owing to the widening, or owing to the comparatively narrower region of the mechanically supporting layer. Owing to the widening, the lattice webs form an essentially T-shaped cross-sectional profile. The contour of the widening may vary along the lattice web in such a way that the widening forms projections. The inner layer is in this case formed to be narrower than the outer layer. During compression of the lattice structure, the inner layers of the lattice webs can bear on one another in the circumferential direction, with the widening of the lattice webs respectively overlapping. Overall, the cross-sectional diameter of the lattice structure in the compressed state is therefore reduced.

Preferably, the widening has at least one electrically conductive layer and at least one mechanically supporting layer, in particular of different materials. The electrically conductive layer may, like the outer layer and the mechanically supporting layer, form an interlayer which is arranged between the outer layer and the inner layer.

In another preferred embodiment of the electrode according to the invention, at least one lattice web, in particular a plurality of lattice webs, are respectively connected to at least one cover, the longitudinal direction of which differs from the longitudinal direction of the lattice webs in such a way that the cover extends into at least one adjacent cell and at least partially covers the latter. By virtue of the cover, the geometrical shape of the individual layers of the lattice webs can be varied. Furthermore, in this embodiment as well, the area of contact with the hollow organ is enlarged, as a result of which a gentle treatment is made possible so that heating of the tissues is limited and necrosis is avoided.

The size and/or geometry of the covers may be at least partially equal or different. In addition or as an alternative, the number of covers may vary on the circumference of the lattice structure and/or in the longitudinal direction of the lattice structure. Therefore the electrical properties, in particular the modulation properties, of the electrode can thereby be influenced.

The covers may be electrically conductively connected, in particular to one another, by an electrical supply layer. The electrical supply layer is arranged on the outer side or on the inner side of the covers. The electrical supply layer may be arranged on the same plane as the cover. Furthermore, the electrical supply layer corresponds to the arrangement of the lattice webs, the electrical supply layer arranged on the inner side of the covers forming the mechanically supporting layer or a layer electrically insulated from the mechanically supporting layer. The electrical supply layer may be formed by an electrically conductive layer, which is separated from the mechanically supporting layer by an insulator layer, or an electrically insulated layer.

The externally arranged electrically conductive layer, in particular the widening or the cover, may be structured in order to increase the contact area. For example, the externally arranged electrically conductive layer may have grooves, recesses, projections or similar structures, even to the extent of nanostructures, which increase the overall contact area between the externally arranged electrically conductive layer and the body tissue, in particular a vessel wall of a hollow body organ.

A guide wire connected solidly or releasably to the lattice structure may be adapted for the electrical supply. The design and structure of the electrode is therefore simplified, since the guide wire can be used on the one hand for the delivery of the lattice structure to a treatment site and on the other hand as an element delivering current.

Furthermore, regions of the lattice structure may be formed to be externally electrically insulating and other regions of the lattice structure are formed to be externally electrically conductive.

According to a co-coordinated aspect, the invention is based on the concept of providing a system having an electrode as described above, as well as an electrical supply, a pulse generator and control electronics, which are coupled or couplable to the electrode. The invention therefore relates both the electrode per se, i.e. independently of the overall system, and to the overall system having such an electrode.

The system may comprise at least one further electrode for medical applications, which interacts with the electrode according to the invention or an electrode according to one of the embodiments according to the invention as mentioned above. In particular, the further electrode is actively connected or actively connectable to the electrode described above, in such a way that a bipolar electrical supply can be set up. In this way, the application possibilities of the electrode, or in general of the overall system, are expanded. The further electrode may, for example, be an extracorporeal electrode and/or a further implantable electrode and/or the catheter tip and/or the guide wire of an associated delivery system.

The method according to the invention for producing the electrode as described above is based on the lattice structure being produced at least partially by physical vapor deposition, a material being deposited layer-wise on a substrate and structured in such a way that a self-supporting lattice structure or a coated lattice-like carrier structure is formed. The use of physical vapor deposition methods, in particular PVD methods, preferably sputtering methods, for producing the electrode makes it possible to form lattice webs having various layers of different materials. In this way, insulating layers and electrically conductive layers can be applied in a controlled way. The method according to the invention therefore allows flexible production of the electrode, in which case the different layers may be arranged according to the requirements of the electrode and formed with a view to the geometrical shape of the electrode. In this case, in particular, a combined etching/sputtering method may be employed. Furthermore, particularly favorable material properties are achieved.

The invention will be explained in more detail below with the aid of exemplary embodiments with reference to the appended schematic drawings, in which

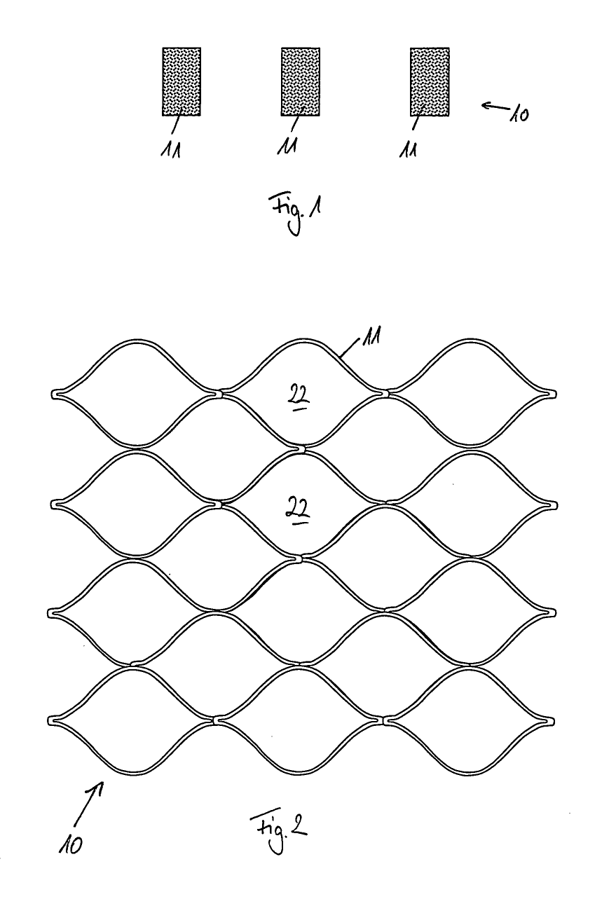

FIG. 1 shows a longitudinal section through the lattice structure of an electrode according to an exemplary embodiment according to the invention;

FIG. 2 shows a plan view of the electrode according to FIG. 1;

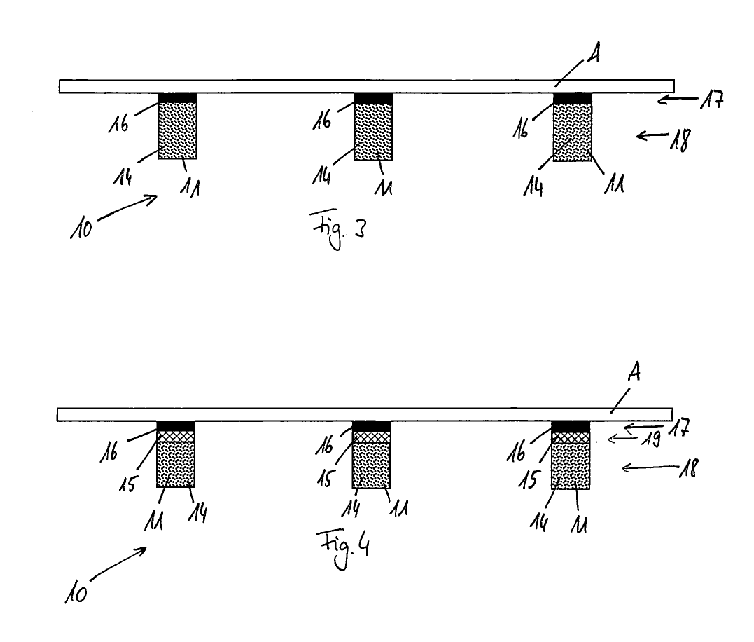

FIG. 3 shows a longitudinal section through the lattice structure of an electrode according to another exemplary embodiment according to the invention in the implanted state, the lattice webs having an outer layer and an inner layer;

FIG. 4 shows a longitudinal section through the lattice structure of an electrode according to another exemplary embodiment according to the invention in the implanted state, the lattice webs comprising an outer layer, an inner layer and an interlayer;

FIG. 5 shows a longitudinal section through a lattice structure of an electrode according to another exemplary embodiment according to the invention in the implanted state, the outer layer of the lattice webs having a widening;

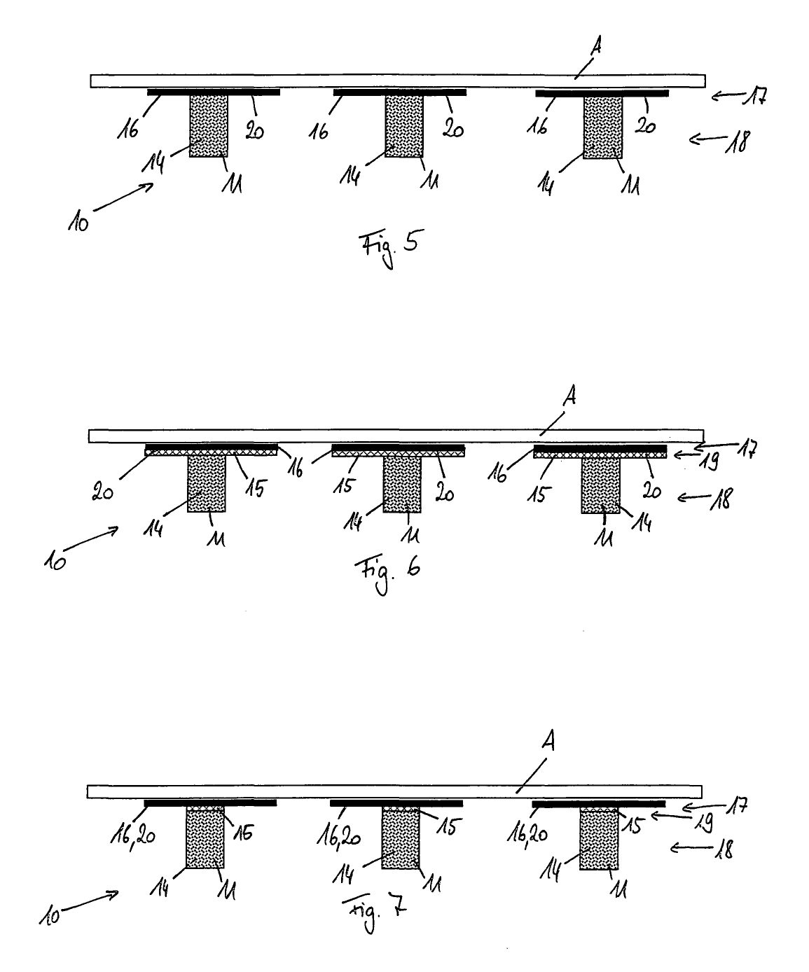

FIG. 6 shows a longitudinal section through a lattice structure of an electrode according to an exemplary embodiment according to the invention in the implanted state, the widening comprising a plurality of material layers;

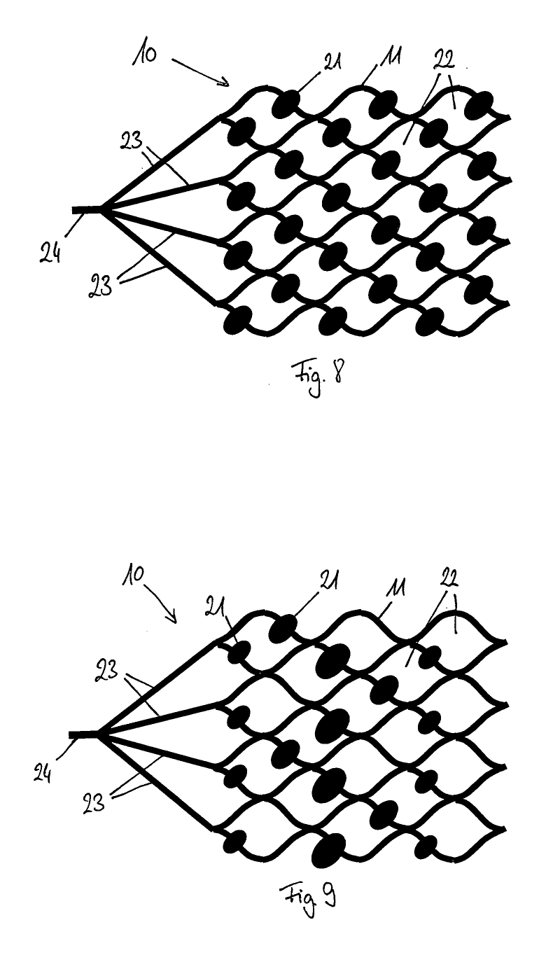

FIG. 7 shows a longitudinal section through a lattice structure of an electrode according to an exemplary embodiment according to the invention in the implanted state, the lattice webs having a widening in the electrically conductive layer and a multilayer structure in the mechanically supporting structure;

FIG. 8 shows a plan view of an electrode according to another exemplary embodiment according to the invention, at least some of the lattice webs having a cover;

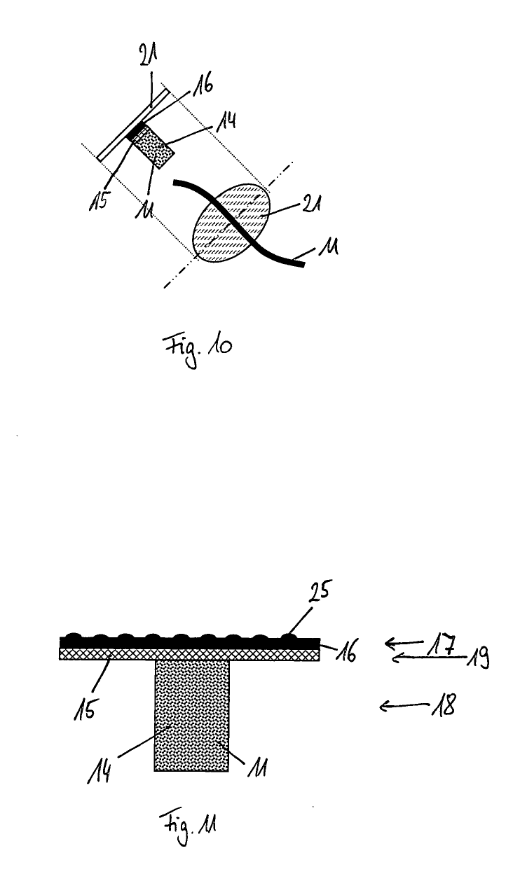

FIG. 9 shows a plan view of an electrode according to another exemplary embodiment according to the invention, the lattice webs comprising differently large covers;

FIG. 10 shows two views of a lattice web having a cover;

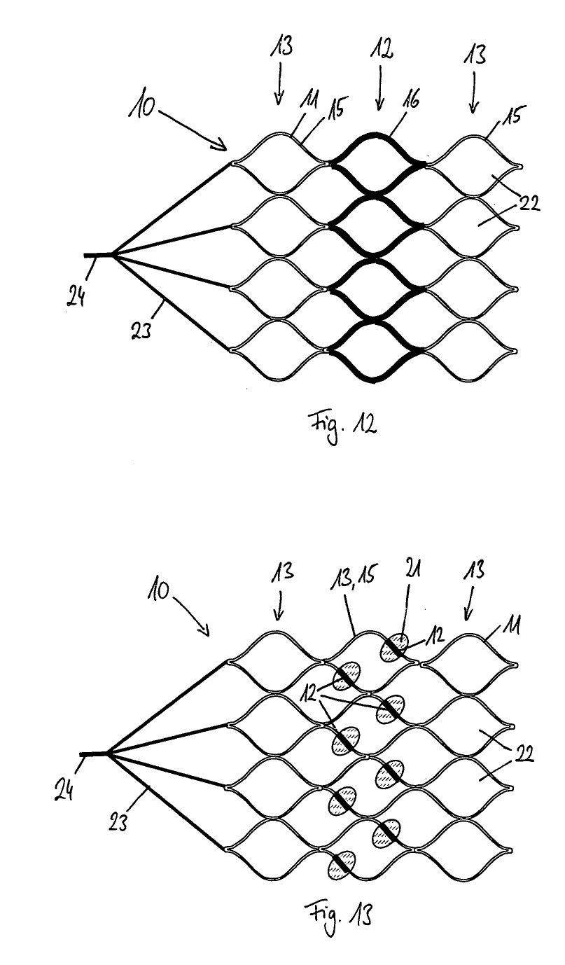

FIG. 11 shows a longitudinal section through the lattice structure of an electrode according to another exemplary embodiment according to the invention, the electrically conductive layer being structured;

FIG. 12 shows a plan view of an electrode according to another exemplary embodiment according to the invention, differently electrically conductive or electrically insulating regions being provided;

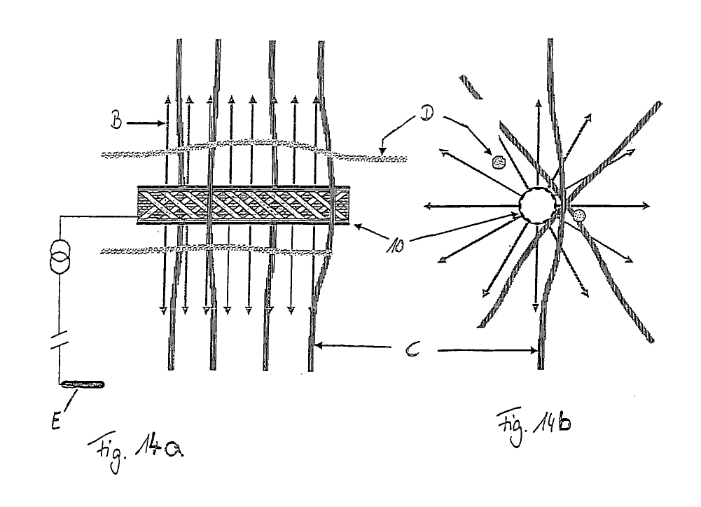

FIG. 13 shows a plan view of an electrode according to another exemplary embodiment according to the invention, having covers which provide an electrically conductive surface in contrast to the free lattice webs;

FIG. 14a shows a side view of an electrode according to another exemplary embodiment according to the invention in the implanted state, with representation of the electric field profile; and

FIG. 14b shows a cross-sectional view through the electrode according to FIG. 14a.

FIGS. 1 and 2 represent an example of an electrode according to the invention, which has both improved mechanical properties and improved electrical properties. The electrode is intended for medical applications in which the lattice structure is introduced into a hollow organ of a body. This may involve endovascular applications or other applications, for example in the urethra. The electrode, and in particular the dimension thereof, is adapted to the various applications.

The electrode is produced by physical vapor deposition.

The implantable electrode may be arranged temporarily or permanently in a hollow organ of a body. In other words, the electrode is adapted for temporary or permanent arrangement in a hollow organ of a body.

The electrode has a lattice structure 10, which is formed by lattice webs 11. In a manner known per se, the lattice webs 11 form cells 22. To this end, the lattice webs 11 are locally connected to one another, or have connectors which connect the webs in order to form the cells 22. The lattice structure may have an open or open-cell, or a closed or closed-cell structure. The different structures are distinguished as open-cell design or closed-cell design and are known to the person skilled in the art. The lattice structure formed by lattice webs 11 differs from lattice structures which are formed as wire mesh not on the basis of lattice webs 11, but on the basis of filaments or wires. In particular, the lattice structures 10 which are disclosed in the scope of the invention and consist of lattice webs 11 have different mechanical properties to wire mesh. Furthermore, the way in which wire meshes are produced differs significantly from the way in which lattice structures 10 that comprise lattice webs 11 are produced. The advantages achievable according to the invention in relation to the electrical properties, or the increased conductivity, of the lattice structure 10 are not achievable in the case of meshes. The methods used for the production of lattice structures 10 based on lattice webs 11, conversely, are suitable for forming a particularly conductive electrode which furthermore permits a comparatively homogeneous electric field. A physical vapor deposition method is used, so that the lattice structure 10 can be produced rapidly both in a flat basic shape and in a three-dimensional basic shape, in particular a cylindrical shape, lattice structure defects in the material, particularly precipitates and/or inclusions, being controllable or adjustable.

The lattice webs 11 of the lattice structure 10 preferably have a rectangular cross-sectional profile, as represented in FIG. 1. The edges of the lattice webs may be rounded. Other shapes are possible. In particular, the production method for the lattice structure 10 may comprise an etching step the edges of the lattice web 11 being etched in a controlled way. In this way, atraumatically formed lattice webs 11 can be provided. The lattice webs 11 are furthermore elastically deformable, so that the lattice structure can be converted from a compressed state into an expanded state and vice versa. Preferably, the shape of the lattice structure 10 corresponds to the shape of a stent. In other words, the electrode may have a stent structure. The lattice structure 10 is preferably rotationally symmetrical, in particular hollow-cylindrical. The embodiment according to FIGS. 1 and 2 is a stent electrode, i.e. an electrode having a tubular lattice structure 10. The invention also covers lattice structures 10 having a different shape, for example filters. In general, the lattice structure 10 may have any desired combinable and expandable shape which is suitable for being introduced into a hollow organ by a delivery system.

The lattice structure 10 may be deposited on a flat substrate by physical vapor deposition. As an alternative, the substrate may form a cylindrical mandrel so that the material of the lattice structure is deposited tubularly onto the substrate. When using a fat substrate, it is advantageous subsequently to convert the deposited, or fabricated, flat lattice structure 10 into a tubular shape. In this case, the free edges of the lattice structure 10, which touch after conversion into the tubular shape, are connected to one another. The connection may, for example, be carried out by welding, adhesive bonding, soldering and/or a form fit. Furthermore, the lattice structure 10 may be converted into a C-shaped three-dimensional shape, so that a gap is formed between the free edges of the lattice structure 10. The free edges of the lattice structure 10 may also overlap. In other words, after production on a flat substrate, the lattice structure 10 may be rolled about a longitudinal axis, with regions of the lattice structure 10 overlapping.

The lattice structure 10 may in general be formed so as to be self-expandable. This means that the lattice structure 10 automatically assumes the expanded state when an external constraint, which acts on the electrode for example because of the delivery system, is removed. As an alternative, the lattice structure 10 may be formed to be balloon-expandable. In this case, a force is required for widening, or expansion, of the lattice structure 10. The required force is preferably exerted by an expandable balloon at the tip of a delivery system. The lattice structure 10 encloses the balloon, so that when the balloon expands the lattice structure 10 is pressed apart, or converted into the expanded state.

The lattice structure 10 of the electrode may have a plurality of material layers with different properties, or functions. The layers may consist of different materials or the same materials, i.e. the same chemical compositions, and differ in their structural properties. For all implementation examples and embodiments, it applies that at least one layer at least locally has the structural properties, achievable by the PVD method, which are disclosed in this application. It is possible for all layers to have the desired structural properties. The structural properties are set by the PVD method, in particular by sputtering. For example, the conductive region, in particular the outer layer, may have the desired structural properties and is produced by the PVD method. The carrier structure is produced in a conventional way, for example by laser cutting. This has the advantage that the outer layer having the improved material properties comes into contact with the tissue. When the entire lattice structure in the radial direction, i.e. all layers are arranged above one another, are produced by the PVD method, both the mechanical and electrical properties of the electrode are improved. The layer thickness with the sputtered material is at least 2%, in particular at least 5%, in particular at least 10%, in particular at least 15%, in particular at least 20%, in particular at least 25%, in particular at least 30%, in particular at least 35%, in particular at least 40%, in particular at least 45%, in particular at least 50%, in particular at least 55%, in particular at least 60%, in particular at least 65%, in particular at least 70%, in particular at least 75%, in particular at least 80%, in particular at least 85%, in particular at least 90%, in particular at least 95%, in particular 100%, of the wall thickness of the lattice structure.

FIG. 3 represents the lattice structure 10 of an electrode, which comprises an outer layer 17 and an inner layer 18, in the implanted state. In the implanted state, the outer layer 17 bears on a hollow organ A. Preferably, the outer layer 17 primarily has electrically conductive properties, or an electrically conductive function. The inner layer, on the other hand, is formed as a mechanically supporting layer, i.e. the inner layer 18 predominantly has mechanically supporting functions. In order to improve the electrically conductive properties, the outer layer preferably comprises a material which achieves improved electrical contact between the electrode and the hollow organ A. Such a material may, for example, be gold. Other possible materials include silver, iridium, iridium oxide, tantalum, titanium, titanium nitride, niobium and alloys thereof, which are biocompatible. The use of gold or platinum or tantalum for the outer layer 17 is furthermore advantageous since in this way the X-ray visibility of the electrode, or of the lattice structure 10, is increased. The inner layer 18, on the other hand, preferably comprises a shape memory material, in particular a shape memory alloy, for example Nitinol. Owing to the pseudoelastic properties of the shape memory material, which may generally comprise a nickel/titanium alloy, the stability, but in particular the flexibility, of the lattice structure 10 is increased. The lattice structure 10 has good deformability, so that the lattice structure 10 adapts to the structure of the hollow organ A. The lattice structure 10 is braced on the hollow organ A. In this way, the inner layer 18 or in general the mechanically supporting layer, advantageously contributes to improving the electrical contact between the outer layer 17 and the hollow organ A. The mechanically supporting layer may, as an alternative or in addition, comprise other materials, in particular cobalt/chromium or steel or a biodegradable material. The supporting layer may be formed from a nonconductive material.

The invention is not restricted to two layers in the lattice structure 10. Rather, in the scope of the invention it is possible to provide more than two layers, in particular three, four, five, six, seven, eight or more than eight layers for forming the lattice structure 10. For example, the provision of a multilayer configuration of the lattice structure 10 may be envisioned, the mechanically supporting layer being arranged between two further layers. The mechanically supporting layer may thus form an interlayer 19. The interlayer 19 is preferably arranged between the outer layer 17 and the inner layer 18. If the interlayer 19 is formed by the mechanically supporting layer, then the outer layer may advantageously have a highly electrically conductive layer, for example comprising gold, while the inner layer 18 comprises an X-ray visible layer, for example of tantalum or platinum. As an alternative, the X-ray visible layer may form the interlayer 19. In this case, the mechanically supporting layer preferably forms the inner layer 18. The outer layer 17 comprises a highly electrically conductive material.

Furthermore, in the case of a lattice structure 10 which has at least three different layers, the interlayer 19 or at least one of the interlayers 19 may form an insulator layer 15. The insulator layer 15 may, for example, comprise an oxide. FIG. 4 represents an example of the lattice structure of an electrode in the implanted state, an insulator layer 15 being arranged as an interlayer 19 between the outer layer 17, which forms an electrically conductive layer 16, and the inner layer 18 which forms a mechanically supporting layer 14. The insulator layer 15 DC-separates the electrically conductive layer 16 from the mechanically supporting layer 14.

In this context, it is to be pointed out that the terms “electrically conductive layer” and “mechanically supporting layer” reflect the preferred or primary function of the respective layers. This does not exclude, for example, the mechanically supporting layer also comprising electrically conductive properties. Likewise, the electrically conductive layer may have mechanically supporting functions. What is essential in the scope of the application is that the corresponding layers respectively have a main function, or are adapted for a main function, the main function of the electrically conductive layer being characterized by an increased conductivity and the main function of the mechanically supporting layer being characterized by increased stability.

In the exemplary embodiment according to FIG. 4, the interlayer 19 is formed as an insulator layer 15. The effect achieved by this is that the flow of current in the electrode is restricted to the outer layer 17, i.e. the electrically conductive layer 16. Direct charge exchange between the outer layer 17 and the inner layer thus does not take place. Although currents may occur owing to induction in the inner layer 18, or the mechanically supporting layer 14, this effect is negligible since the currents in the electrode are selected to be correspondingly small. This applies in particular when using the electrode for signal acquisition, the electrical potentials within the human body being comparatively small. Furthermore, inductive effects can be reduced or prevented by selection of the corresponding materials, in particular for the mechanically supporting layer 14 and the insulator layer 15.

It is also possible to form the outer layer 17 and the inner layer 18 as poles of the electrode, to which poles the same or different voltages can be applied. To this end, the two layers 17, 18 are respectively connected to a separate electrical supply.

As represented in the exemplary embodiment according to FIG. 1, the lattice structure 10 as a whole may advantageously have electrically conductive properties. The material of the lattice structure 10 may also comprise a double function, namely on the one hand providing sufficiently mechanically supporting functions in order to fix the electrode, or the lattice structure 10, efficiently in a hollow organ, and on the other hand providing electrically conductive properties which permit electrical stimulation of body tissue or electrical signal acquisition of electrical cell potentials. This does not exclude contact of the electrically conductive layer 16, or of the overall electrically conductive lattice structure 10, with body fluids, in particular blood, leading to an increase in the biocompatibility of the electrode. In this case, the thrombogenicity can be reduced and the susceptibility to endothelialization can be improved. On the other hand, electrical contact between the electrode and body fluids, in particular blood, may be regarded as disadvantageous in certain applications, so that in these cases the use of a multilayer lattice structure 10 is advantageous, the area of electrical contact with the body fluid or the blood being limited to a minimum. The person skilled in the art will select the corresponding variant of the lattice structure 10, or in general the electrode, with the aid of the respective medical specifications.

It is furthermore possible for the lattice structure 10 to have a multilayer configuration, with an interlayer separating two electrically conductive layers 16 from one another. The electrically conductive layers 16 may be assigned different functions, in particular therapeutic functions. For example, the outer layer 17 may be formed as an electrically conductive layer 16, an electrical signal with which electrical stimulation of body cells is achieved, in particular nerve cells, being applied to the outer layer 17. The inner layer 18, on the other hand, may form an electrically conductive layer 16 which is driven with electrical signals in such a way that the biocompatibility of the electrode is increased. Specifically, different electrical voltages may be applied to the different electrical layers 16, i.e. the outer layer 17 and the inner layer 18. Other parameters, which may be varied in individual electrical layers 16, are the current strength, the pulse frequency or in general the current profile.

The lattice structure 10 may furthermore be loaded with at least one medicament. In other words, the lattice structure 10 may comprise a layer carrying medicament. Preferably, the layer carrying medicament is directly connected to an electrically conductive layer 16, so that at least parts of the medicament, or of the therapeutically effective substances, can be released by applying a voltage, or in general an electrical signal, to the electrically conductive layer 16. The medicament may in this case be provided on the surface or in the material.

The mechanically supporting layer 14 may comprise a biodegradable material, for example magnesium or an iron alloy. The biodegradable mechanically supporting layer 14 initially imparts sufficient mechanical stability to the lattice structure 10 so that the lattice structure 10 can be used to support a hollow body organ A. In the course of time, the biodegradable layer is degraded, the lattice structure 10 simultaneously being incorporated by endothelial cells. The comparatively thin electrically conductive layer 16 remains, i.e. is not degraded. Owing to the degradation of mechanically supporting layer 14, the hollow organ A is mechanically relieved of stress so that the original compliance of the hollow organ A is restored. Owing to the comparatively thin layer thickness of the electrically conductive layer 16, the subordinate mechanical supporting function of the electrically conductive layer 16 has only a negligible effect on the biomechanics of the hollow organ A. It is also possible for the entire electrode to be biologically degradable.

The production method according to the invention, namely the use of physical vapor deposition, in particular a PVD method or sputtering method, allows the production of a multilayer configuration of the lattice structure 10 in a particularly straightforward way. In particular, the various layers of the lattice structure 10 can be produced in a single method step. In this case, a material-fit connection occurs between the individual layers. In other words, the lattice structure 10 is constructed layer-wise by the method according to the invention. In contrast to conventional methods for the production of endovascular electrodes, in which a plurality of parts or components are produced separately and subsequently connected to one another, the method of physical vapor deposition makes it possible to construct a plurality of layers in one method step, the lattice structure being constructed integrally and layer-wise. It is to be understood that the individual functionally separated layers 14, 15, 16 themselves are in turn constructed layer-wise and form laminates. This results from the production of the layers by deposition methods, in particular by sputtering.

In order to achieve a gentle treatment with relatively low current densities, the contact area between the lattice structure 10 and the hollow organ A is preferably increased. Corresponding exemplary embodiments of the invention are represented in FIGS. 5 to 7, the lattice webs 11 comprising a widening 20. In particular, the electrically conductive layer 16 of the lattice webs 11 respectively comprises the widening 20. The widening 20 follows the profile of the lattice webs and extends in the longitudinal direction of the lattice webs 11 in such a way that the region of the lattice webs 11 which comes in contact with the hollow organ A is wider than the region of the lattice webs 11, in particular the mechanically supporting layer 14, further away from the hollow organ A. In cross-sectional profile, the lattice web 11 comprising the widening 20 essentially has a T-shape. A possible method for producing the widening 20 is disclosed in DE 10 2008 010 507, which is in the name of the Applicant and discloses connection of the lattice webs 11 to flexible contact elements by sputtering. The content of DE 10 2008 010 507 is fully incorporated into the present application by reference.

FIG. 5 shows a longitudinal section through the lattice structure 10 of an electrode, the lattice webs 11 having a two-layer structure according to FIG. 3, with an inner layer 18 formed as a mechanically supporting layer 14 and an outer layer 17 formed as an electrically conductive layer 16, which comprises a widening 20. The exemplary embodiment according to FIG. 5 thus differs from the exemplary embodiment according to FIG. 3 in that the electrically conductive layer 16 is widened. The area of contact with the hollow organ A is thereby increased. The widening 20 and the mechanically supporting layer 14 may comprise the same material. In this case, the widening 20 and the mechanically supporting layer 14 preferably comprise nickel/titanium alloys, in particular Nitinol, or in general a pseudoelastic material. The use of pseudoelastic materials for the widening 20 allows very flexible behavior of the widening 20, so that when the lattice structure 10 is compressed, a plurality of widenings 20 arranged on the circumference of the lattice structure 10 can avoid one another or overlap or slide on one another or elastically deform. The compressibility or crimpability, or the degree of maximum possible compression, is therefore increased. Furthermore, an increased flexibility of the widening 20 allows improved bearing of the lattice structure 10 on the hollow organ A.

Lattice structures having widenings, or covers, and methods for the production thereof are described in DE 10 2008 010 507, DE 10 2009 060 228 and DE 10 2009 060 280, which are fully incorporated into the present application by reference.

The widening 20 and the mechanically supporting structure 14 may comprise different materials. For example, the mechanically supporting layer 14 may have a shape memory material and the widening 20 may have a material with increased conductivity, for example gold. The electrical properties of the lattice structure 10, or in general the electrode, can be improved in this way.

The widening 20 may furthermore have a plurality of layers. For example, the widening 20 may, as represented in FIG. 6, have an electrically conductive layer 16 as the outer layer 17 and an insulator layer 15, which is arranged radially further inward. The insulator layer 15 may, in particular, be formed in a similar way to the exemplary embodiment according to FIG. 4 as interlayer 19, which separates the electrically conductive layer 16 (outer layer 17) from a mechanically supporting layer 14 (inner layer 18). In the exemplary embodiment according to FIG. 6, the insulator layer 15 extends over the entire width of the widening 20, or forms a part of the widening 20. The mechanically supporting layer 14, on the other hand, is formed to be narrower so that the lattice structure 10 has good crimpability overall. Preferably, the widening 20, in particular the electrically conductive layer 16 and the insulator layer 15, are formed in this way to be thin and flexible so that the crimpability of the lattice structure 10 is not compromised, or is at least compromised only insubstantially.

The interlayer 19 according to FIG. 6 may comprise a shape memory material, for example a nickel/titanium alloy. The interlayer 19 in this case determines the flexibility of the widening 20. The electrically conductive layer 16 of the widening 20 may, on the other hand, have a material with increased electrical conductivity properties, for example gold. Preferably, the electrically conductive layer 16 comprises a layer thickness which corresponds at most to the layer thickness of the interlayer 19. In particular, the layer thickness of the electrically conductive layer 16, or outer layer 17, is at most 100%, in particular at most 80%, in particular at most 40%, in particular at most 20%, in particular at most 10%, in particular at most 5%, in particular at most 2%, in terms of the layer thickness of the interlayer 19 or of the inner layer 18. The interlayer 19 may also form an insulator layer 15 or comprise an insulating material. The outer layer 17 may have a shape memory alloy, for example Nitinol. The widening 20 is not restricted to a one- or two-layer structure. Rather, the widening 20 may also comprise three or more layers.

In the embodiment according to FIG. 6, the interlayer 19 extends over the entire width of the widening 20. The interlayer 19 is thus assigned to the widening 20. As an alternative, the interlayer 19 may be assigned to the inner layer 18, or mechanically supporting layer 14, as represented in FIG. 7. In other words, the width of the interlayer 19 in the embodiment according to FIG. 7 corresponds to the width of the mechanically supporting layer 14. A further consideration consists in assigning the interlayer 19 according to FIG. 7 to the lattice webs 11, which additionally comprises a widening 20 that is connected to the interlayer 19. In the scope of this consideration, it should be mentioned that both the lattice web 11 and the widening 20 may respectively have a multilayer construction. It is to be pointed out that the widening 20 and the lattice web 11 are integrally connected to one another. In particular, the widening 20 is formed integrally with the lattice web 11 by the layer-wise construction of the lattice structure 10 by means of the vapor deposition method.

FIG. 8 represents an exemplary embodiment of the electrode, the lattice structure 10 comprising lattice webs 11 which have a cover 21. The cover 21 may be provided as an alternative or in addition to a widening 20. The cover 21 is connected to a lattice web 11 and forms at least a part of the outer surface of the respective lattice web 11. In this case, the longitudinal direction of the cover 21 differs from the longitudinal direction of the respective lattice web 11. Specifically, the cover 21 respectively extends into the bounding cells 22 and covers the latter at least partially. In the exemplary embodiment according to FIG. 8, the longitudinal direction of the cover 21 extends transversely to the longitudinal direction of the respective lattice web 11. In this case, each cell 22 may be assigned one or more covers 21. According to FIG. 8, each cell 22 is respectively assigned two covers 22. In FIG. 8, it can furthermore be seen that not all lattice webs 11 have a cover 21. Rather, the lattice structure 10 comprises lattice webs 11 which are provided with a cover 21 and further lattice webs 11, which are formed cover-free. Specifically, in the exemplary embodiment according to FIG. 8 every other lattice web 11 is equipped with a cover 21.

The covers 21 according to FIG. 8 are respectively arranged at an angle of 90 degrees relative to the respective lattice web 11, respectively in relation to the longitudinal direction of the cover 21, or of the lattice web 11. A different orientation of the cover 21 is possible. The cover 21 is furthermore formed ovally, further or other geometrical shapes being possible, for example circular covers 21. The same applies for the size of the cover 21, which may be adapted in such a way that the cover 21 uncovers the respective cell with different degrees of coverage. For example, the cover 21 may cover the respective cell 22 in such a way that neighboring covers 21 overlap in the expanded state of the lattice structure 10. The cover 21 and the associated lattice web 11 may consist of the same or different materials. The cover 21 and the associated lattice web 11 may be formed integrally. In this context, reference is made to the explanations regarding the widenings 20.

The difference between a cover 21 and a widening 20 is that the widening 20 follows the profile of the lattice web 11, i.e. it is arranged essentially parallel to the lattice web 11. The cover has a longitudinal extent which differs from the profile of the lattice web 11. Intermediate forms are possible, which combine covers and widenings 20, for example widenings 20 which project laterally in relation to the associated lattice web 11, the projection extending into a cell. The covers 21 and widenings 20 form an outer layer 17 on the supporting layer 14. They may be formed from the same material as the supporting layer 14, an insulator layer 15 being arranged between the covers 21 and widenings 20, on the one hand, and the supporting layer 14, on the other hand, in the case of a conductive material.

For connection of the electrode to the electrical supply, or the electrical feed, FIG. 8 represents a central supply line 24 which combines a plurality of individual supply lines 23. The central supply line 24 can fulfill central functions and, for example, may be formed as an actuation means for the delivery or retraction of the electrode. Specifically, the central supply line 24 may form a guide wire. The individual supply lines 23 are connected to the lattice webs of the lattice structure 10. The supply lines 23 may be connected to individual layers, in particular to the conductive layers or layer 16. In the exemplary embodiment according to FIG. 8, four supply lines 23 are provided. A different type of the supply lines 23 is possible. In particular, it is also possible for the central supply line 24 to be connected directly to the lattice structure 10.

In general, the electrode is coupled to an electrical supply, or electrical feed, or is couplable to an electrical feed. To this end, the electrode, or the lattice structure 10, may be connected by a line to an electrical feed (not shown). The electrical feed of the electrode may be formed as a module together with a pulse generator and control electronics. The connection between the electrical feed and the electrode may be carried out on the one hand by an electrical line, in particular a wire, or the central supply line 24. It is possible to use batteries which are capable of functioning lifelong or at least for the duration of the treatment.

On the other hand, it is possible for the connection between the electrical feed and the electrode to be carried out wirelessly, for example by induction of an electric current in the lattice structure 10 by means of a transcutaneous energy transfer system (TET system). To this end, the electrode has a means for coupling to an electrical feed, or has an electrical transmission means, in particular for inductive electrical transmission, which is connected to the lattice structure, in particular to the electrically conductive layer 16. In this case, the electrode comprises a receiver, in particular a reception coil, which is electrically coupled at least to the electrically conductive layer 16 of the lattice structure 10. The receiver, or the reception coil, can be excited by an extracorporeal transmitter, or an extracorporeal transmission coil. In this way, an electric voltage can be introduced in the reception coil, or in the receiver.

In addition to the reception coil, it is possible to provide a pulse generator and control electronics, which are connected to the lattice structure 10. The pulse generator and the control electronics may also be arranged extracorporeally and communicate with the reception coil, or a suitable receiver, wirelessly, in particular by radio. It is furthermore possible to integrate a rechargeable battery, or a capacitor, into the electrode which can be recharged by the reception coil using a charging device. Such systems for transcutaneous energy transmission are known per se and may be used together with the invention. Both the electrode per se, with the means for coupling to an electrical supply, and the system described above, having such an electrode, are disclosed.

FIG. 9 shows another exemplary embodiment of the electrode, the exemplary embodiment according to FIG. 9 differing from the exemplary embodiment according to FIG. 8 in that the covers 21 are distributed inhomogeneously over the lattice structure 10. The covers 21 furthermore have different sizes. Overall, the density of the covers 21, or the area of contact of the covers 21 with the hollow organ A, may be varied over the entire surface of the lattice structure 10. By the different geometrical dimensions of the individual covers 21 and the variable distribution of the covers over the lattice structure 10, the therapeutically effective, or generated, electric field can be adjusted essentially in any desired way. The person skilled in the art will select the adjustment of the electric field, i.e. the geometrical arrangement and distribution of the covers 21, with the aid of medical specifications, in particular while taking into account the disease to be treated.

For the two exemplary embodiments according to FIGS. 8 and 9, the outer layer 17 of the lattice webs 11 may be formed to be either electrically conductive or electrically insulating. In particular, the outer layer may form an electrically conductive layer 16, so that the entire surface of the lattice structure 10, including the covers 21, is used for electrical coupling of the electrode to the hollow organ A. As an alternative, the lattice webs 11 may comprise an insulator layer 15 as the outer layer 17, so that the electrical contact between the electrode and the hollow organ A takes place exclusively through the covers 21.

To this end, the covers 21 are connected to an electrically conductive layer 16 arranged below the insulator layer 15. In this way, the covers 21 are electrically coupled to one another, the lattice webs 11 not engaging in direct electrical connection to the hollow organ A. It is also possible to form the cover 21 and the outer layer 17 to be electrically conductive in a region of the lattice webs 11 around the cover 21. Overall, there are many design possibilities which allow modulation of the electric field that can be generated by the electrode.

The production of the cover 21 or widening 20 is preferably carried out by a structuring method, for example lithographic etching. In this case, the lattice structure 10 or at least individual layers of the lattice structure, for example the insulator layer or the conductive layer 16, are initially constructed layer-wise by the physical vapor deposition process and the cells 22 are subsequently exposed by the etching method, the shape and dimension of the covers 21, or widenings 20, and lattice webs 11 having been established beforehand by a corresponding lithographic mask. In this case, an insulator layer 15 may be provided in sections below the covers 21. At least in one subregion of the lattice web 11 and of the cover 21, an electrical connection between an electrically conductive layer 16 and the cover 21 is provided. It is also possible for the conductive layer 16 and the cover to be arranged in the same plane and for the electrical connection to be formed at the contact point between the conductive layer 16 and the cover 21. In a similar way to the widening 20, the cover 21 may be constructed with multiple layers. Preferably, the cover 21 comprises at least one electrically conductive layer 16, which forms an outer layer 17 of the lattice structure 10, i.e. it establishes an electrical contact with the hollow organ A. The cover 21 is electrically coupled to further covers 21.

The cover 21 may comprise an elastic material. During compression of the lattice structure 10, neighboring covers 21 slide over one another and overlap, so as not to hinder compression of the lattice structure 10.

FIG. 10 shows a possible layer structure of a lattice web 11 having a cover 21. In this case, the lattice web 11 comprises a mechanically supporting layer 14 which forms the inner layer 18 of the lattice structure 10. An insulator layer 15, which forms an interlayer 19, is arranged on the mechanically supporting layer 14. Arranged on the interlayer 19, or insulator layer 15, there is furthermore an electrically conductive layer 16 which at the same time has elastic properties. The electrically conductive layer 16 forms a second interlayer 19. The outer layer 17 of the lattice web 11 is formed by the cover 21, which likewise comprises an electrically conductive material. The electrical contact between a plurality of covers 21 takes place through the electrically conductive layer 16.

The outer layer 17, in particular the cover 21 or the widening 20, may be structured in order to increase the electrical contact area. For example, the outer layer may have grooves, recesses, projections or other structures, so that the overall electrical contact area is increased. Such structuring 25 is represented by way of example in FIG. 11. In this case, the lattice structure 10 according to FIG. 11 has a lattice web 11, which comprises a mechanically supporting layer 14 as the inner layer 18. The mechanically supporting layer 14 is followed by a cover 21, or widening 20, which has an insulator layer 15 as the interlayer 19. The outer layer 17 of the lattice structure 10 is part of the cover 21, or widening 20, and comprises structuring 25. The structuring 25 may be produced in a straightforward way by the physical vapor deposition method. In this case, the substrate is structured with a corresponding negative shape, so that the structured surface is formed during the vapor deposition, in particular during the sputtering. Furthermore, the structuring 25 may be produced by an etching method following the physical vapor deposition. With both production methods, it is possible to form both round shapes and sharp edges of the structuring 25.

With a view to connecting the electrode to an electrical feed, the central supply line 24 comprises a nickel/titanium alloy, in particular Nitinol. Preferably, the central supply line 4 is configured as a guide wire. Specifically, the central supply line 24 may comprise a cable, which preferably comprises Nitinol, and a plastic sleeve which encloses the cable. The plastic sleeve, the material of which may for example comprise PTFE or PVC, fulfills a double function. On the one hand, the plastic sleeve is used to insulate the current-carrying cable of the central supply line 24. On the other hand, the plastic sleeve offers flexible stabilization of the cable.

In relation to the lattice structure 10, various arrangements of the central supply line 24 may be provided. For example, in terms of the expanded lattice structure 10, the central supply line 24 may be arranged flush with the longitudinal axis of the lattice structure 10. As an alternative, the central supply line 24 may be arranged flush with the outer circumference of the lattice structure 10. The effect achieved by the central supply line being lateral, or arranged in a flush arrangement with respect to the outer circumference of the lattice structure 10, is that the blood flow is essentially not hindered by the central supply line 24 during endovascular use in blood vessels. The central supply line 24 may be solidly connected to the lattice structure 10. As an alternative, the central supply line 24 may be connected releasably, or decouplably, to the lattice structure 10. The latter variant is suitable in particular when using the lattice structure 10 as a permanent implant. It is also possible for the lattice structure 10 to be without a central supply line 24. An electrode comprising a lattice structure 10 which does not have a central supply line 24 is likewise disclosed and claimed in the scope of the application. This will be an electrode having a means for inductive current electrical transmission.

It can be expedient for regions, or sections, of the lattice structure 10 not to comprise an electrically conductive outer layer 17. In this way, electrical signals may be applied to controlled regions inside the hollow organ A, or electrical signals may be acquired in controlled regions of the hollow organ A. Such an embodiment is shown in FIG. 12, the lattice structure 10 comprising two electrically insulated regions 13 and an electrically conductive region 12 arranged between them. The electrically insulated region 13 differs from the electrically conductive region 12 in that the outer layer 17 is formed as an insulator layer 15 in the electrically insulated regions 13 of the lattice structure 10. This does not exclude electrically conductive layers 16, which connect the electrically conductive region 12 to the electrical feed and/or other electrically conductive regions 12, being arranged below the outer layer 17. The production of the electrically conductive region 12 and of the electrically insulated regions 13 may, for example, be carried out by first constructing the lattice structure 10 layer-wise by the physical vapor deposition method, the top layer, in particular an outer layer 17, being produced as an insulator layer 15. Subsequently, the insulator layer 15 is locally removed by a lithographic etching method, so that an underlying electrically conductive layer 16 is exposed. The exposed electrically conductive layer 16 forms the electrically conductive region 12, while the region of the insulator layer 15 not removed by the etching method forms the electrically insulated region 13. It is possible to deposit the insulator layer 15 and the conductive layer at the same height, i.e. in the same plane. It is furthermore possible to apply the insulator layer 15 by a PVD method and to remove the insulator layer locally by etching in order to form the conductive layer 16.

The electrically conductive region 12 may comprise whole cells 22, as represented in FIG. 12.

It is also possible for the electrically conductive region 12 to comprise web sections of the lattice webs 11, as represented in FIG. 13. In this case, the lattice webs 11 are essentially provided with an outer layer 17 formed as an insulator layer 15. A part of the lattice webs 11 respectively comprises a cover 21, an electrically conductive region 12 respectively being provided in the region of the lattice web 11 below the cover 21. In other words, the covers 21 are arranged in electrically conductive regions 12 of the lattice webs 11. The regions of the lattice webs 11 which are arranged outside the covers 21 form the electrically insulated region 13.

The electrode for endovascular medical applications is suitable in particular for the stimulation of nerves which lie in the immediate vicinity of cavities, or hollow organs A and vessels. The endovascular neuromodulation may be used in order to treat vascular diseases such as hemorrhages and ischemic stroke by influencing circulatory parameters such as blood pressure and blood flow, in particular by vascular widening.

This may involve large or small vessels, for example coronary vessels or intracranial vessels, both arteries and veins, for example the carotid artery or the jugular vein. The lattice structure 10 is guided by the central supply line 24 formed as a guide wire through the microcatheter 26 into the blood vessel, where it is released from the microcatheter 26. The lattice structure 10 therefore expands automatically. Via the central supply line 24, a pulsed current is furthermore conducted into the lattice structure 10, so that the electrical stimulation of nerve fibers is induced. The electrical simulation of the nerve fibers causes widening of the blood vessels so that circulatory problems, for example flow problems or blood pressure problems, can be treated.

The electrode, or lattice structure 10, is preferably formed retractably. To this end, an axial end of the lattice structure 10 may comprise an oblique smooth edge so that, when the microcatheter 26 is pushed forward by means of the central supply line 24, compression of the lattice structure 10 takes place as soon as the tip of the microcatheter 26 slides along the oblique end edge of the lattice structure 10.

FIGS. 14a and 14b show the field line profile of the electric field which comes from the lattice structure of the electrode, which interacts with an extracorporeally arranged second electrode (not shown). In the vicinity of the hollow organ A, nerve fibers extend on the one hand parallel to the hollow organ A and on the other hand orthogonally thereto. The electrode, in particular a stent electrode, essentially constitutes a cylindrical electrode, the field lines B of the electric field essentially extending perpendicularly to the surface, or outer circumference, of the lattice structure 10. The effect of this is that the nerve fibers C extending orthogonally to the axis of the lattice structure 10, i.e. orthogonally to the hollow organ A, are stimulated. The nerve fibers D extending parallel to the hollow organ A essentially experience no stimulation by the electric field of the electrode.

Preferably, the electrode is part of a system which additionally comprises an electrical supply, a pulse generator, control electronics and optionally a mating electrode E. The mating electrode E may be formed in a similar way to the electrode. As an alternative, the mating electrode E may be an extracorporeal electrode which is arranged outside the body on the patient's skin. The further electrode, or mating electrode, may also be formed by the tip of the microcatheter 26 or as a guide wire. The electrical contact between the mating electrode E and an electrical supply is established by means of a line which is arranged between two plastic layers in the wall of the catheter. The line may be a wire which extends in the axial direction along the microcatheter. As an alternative, a coil which is provided or a mesh, which supports the microcatheter, may be used as the line. In conjunction with the mating electrode, the system is suitable particularly for the signal acquisition of electrical cell activities. By comparative measurements between the electrode and the mating electrode E, electrical potentials inside the body can be measured and used for further therapeutic measures. To this extent, the system, or the electrode, can be used as a sensor. Preferably, the system, or the electrode, can be used for the acquisition of nerve signals. It is possible to use the system on the one hand for stimulation, i.e. in order to deliver electrical signals into the body tissue, and on the other hand for signal acquisition, i.e. to determine electrical signals from the body tissue. The two functions (simulation and signal acquisition) may be switched between manually or automatically.

Other fields of application of the electrode for endovascular medical applications relate to the treatment of Parkinson's, epilepsy, depression, compulsive behavior or in general therapeutic methods with a view to deep brain stimulation. It is furthermore conceivable to use the electrode in connection with high blood pressure (hypertension), for example in kidney vessels or carotid arteries. The electrode is possible not only in blood vessels, but also in further body cavities, for example the ureters.

The lattice structure 10 preferably comprises a cross-sectional diameter in the production state of between 1 mm and 15 mm, in particular between 2 mm and 10 mm, in particular between 3 mm and 8 mm.

The ratio between a region of the cell 22 which is covered by the cover 21, and a region of the cell 22 which is freely accessible, is preferably at least 10%, in particular at least 20%, in particular at least 50%, in particular at least 70%, in particular at least 90%. Greater coverage of the cell 22 by the cover 21 in the production state is advantageous, as the current density is thereby reduced.

In total, the covers 21, or widenings 20, preferably have a surface area on the outer circumference of the lattice structure 10 which is at least 0.05 mm², in particular at least 0.1 mm², in particular at least 0.2 mm², in particular at least 0.5 mm², in particular at least 0.75 mm², in particular at least 1 mm², in particular at least 2.5 mm², in particular at least 1.5 mm², in particular at least 1.75 mm², in particular at least 2 mm², in particular at least 2.5 mm², in particular at least 3 mm².

The cover 21, or the widening, preferably has a thickness, or wall thickness, which is at most 20 μm, in particular at most 15 μm, in particular at most 10 μm, in particular at most 8 μm, in particular at most 6 μm, in particular at most 5 μm, in particular at most 4 μm, in particular at most 3 μm. This improves the flexibility and crimpability of the system.

The electrode, in particular the lattice structure 10, is preferably adapted in such a way that it can be introduced into a delivery system, in particular a catheter, which has an inner diameter of at most 2 mm, in particular at most 2.8 mm, in particular at most 1.6 mm, in particular at most 1.4 mm, in particular at most 1.2 mm, in particular at most 1.0 mm, in particular at most 0.9 mm, in particular at most 0.8 mm, in particular at most 0.7 mm, in particular at most 0.6 mm, in particular at most 0.52 to mm, in particular at most 0.43 mm.

The lattice webs 11, particularly in the region of the mechanically supporting layer 14, preferably have a web width which is at most 50 μm, in particular at most 45 μm, in particular at most 40 μm, in particular at most 35 μm, in particular at most 30 μm, in particular at most 25 μm, in particular at most 20 μm, in particular at most 15 μm.

All features of the electrode (device) are also disclosed in connection with the method for producing the electrode.

The invention furthermore comprises an electrode for medical applications for neuromodulation and/or nerve stimulation and/or neurological signal acquisition, which is compressible and expandable for introduction into a hollow organ A of a body and is coupled or couplable to an electrical supply. The electrode is distinguished by a compressible and expandable lattice structure 10 which has cells 22 formed by lattice webs and is coupled or couplable to the electrical supply, the lattice structure 10 at least locally having at least two layers 14, 15, 16 arranged successively in the radial direction. The layer structure of the electrode is thereby claimed independently of the production method. All features of the exemplary embodiments explained above are also disclosed and claimed in connection with the layer-wise constructed electrode as claimed in claim 28. The same applies for claims in role 2 to 27, which are likewise disclosed and claimed in connection with the electrode as claimed in claim 28.

### LIST OF REFERENCES

10 lattice structure
11 lattice web
12 electrically conductive region
13 electrically insulated region
14 mechanically supporting layer
15 insulator layer
16 electrically conductive layer
17 outer layer
18 inner layer
19 interlayer
20 widening
21 cover
22 cell
23 supply line
24 central supply line
25 structuring
26 microcatheter
A hollow organ
B field lines
C nerve cells extending orthogonally
D nerve cells extending parallel
E mating electrode

1. An electrode for medical applications for neuromodulation and/or nerve stimulation and/or neurological signal acquisition, which is compressible and expandable for introduction into a hollow organ (A) of a body and is coupled or couplable to an electrical supply, wherein the electrode comprises a compressible and expandable lattice structure which has cells formed by lattice webs and is coupled or couplable to the electrical supply, the lattice structure being obtained at least partially by physical vapor deposition.

2. The electrode as claimed in claim 1, wherein the material of the lattice structure has a maximum density of material inhomogeneities, such as lattice structure defects, adjusted in a controlled way by physical vapor deposition.

3. The electrode as claimed in claim 1, wherein the average grain size of the material of the lattice structure is less than 4 μm, in particular less than 3 μm, in particular less than 2 μm, in particular less than 1.5 μm, in particular less than 1 μm, in particular less than 0.5 μm, in particular less than 250 μm.

4. The electrode as claimed in claim 1, wherein the lattice structure is obtainable at least partially by sputtering or by laser-assisted deposition.

5. The electrode as claimed in claim 1, wherein the material of the lattice structure comprises a shape memory alloy or steel or a chromium/cobalt alloy or a biologically degradable material.

6. The electrode as claimed in claim 1, wherein the lattice structure is formed rotationally symmetrically, in particular hollow-cylindrically, in a production state.

7. The electrode as claimed in claim 1, wherein the lattice structure has a plurality of layers, in particular at least two arranged successively in the radial direction, in particular having different functions.

8. The electrode as claimed in claim 7, wherein the lattice structure has at least one electrically conductive layer and at least one mechanically supporting layer, in particular of different materials.

9. The electrode as claimed in claim 7, wherein the electrically conductive layer is arranged externally for contact with the hollow organ and the mechanically supporting layer is arranged radially further inward in relation to the electrically conductive layer.

10. The electrode as claimed in claim 7, wherein the lattice structure has at least one X-ray visible layer.

11. The electrode as claimed in claim 8, wherein the electrically conductive layer is connected to an electrically insulating layer, in particular an insulator layer, which is arranged on a side of the electrically conductive layer arranged radially inward or radially outward.

12. The electrode as claimed in claim 11, wherein the electrically insulating layer is arranged between two layers to which the same or different electrical voltages can be applied.

13. The electrode as claimed in claim 1, wherein the lattice structure is loaded with at least one medicament which can be released by application of an electrical voltage.

14. The electrode as claimed in claim 7, wherein the mechanically supporting layer is formed from a biologically degradable material.

15. The electrode as claimed in claim 1, wherein the lattice webs have an outer layer and an inner layer, the outer layer having a widening which extends in the longitudinal direction of the lattice webs in such a way that the lattice webs are wider in the region of the outer layer than in the region of the inner layer.

16. The electrode as claimed in claim 15, wherein the widening has at least one electrically conductive layer and at least one mechanically supporting layer, in particular of different materials, the electrically conductive layer forming the outer layer and the mechanically supporting layer forming an interlayer, which is arranged between the outer layer and the inner layer.

17. The electrode as claimed in claim 1, wherein at least one lattice web, in particular a plurality of lattice webs, are respectively connected to at least one cover, the longitudinal direction of which differs from the longitudinal direction of the lattice webs in such a way that the cover extends into at least one adjacent cell and at least partially covers the latter.

18. The electrode as claimed in claim 17, wherein the size and/or geometry of the covers are at least partially equal or different and/or the number of covers varies on the circumference of the lattice structure and/or in the longitudinal direction.

19. The electrode as claimed in claim 17, wherein the covers are electrically conductively connected by an electrical supply layer, which is arranged on the outer side or on the inner side of the covers and corresponds to the arrangement of the lattice webs, the electrical supply layer arranged on the inner side of the covers forming the mechanically supporting layer or a layer electrically insulated from the mechanically supporting layer.

20. The electrode as claimed in claim 9, wherein the externally arranged electrically conductive layer, in particular the widening or the cover, is structured in order to increase the contact area.

21. The electrode as claimed in claim 1, wherein a guide wire connected solidly or releasably to the lattice structure is adapted for the electrical supply.

22. The electrode as claimed in claim 1, wherein regions of the lattice structure are formed to be externally electrically insulating and other regions of the lattice structure are formed to be externally electrically conductive.

23. The electrode as claimed in claim 1, wherein inclusions in the material of the lattice structure have a maximum size of 1 μm, or the material of the lattice structure is free of inclusions.

24. A system having an electrode as claimed in claim 1, an electrical supply, a pulse generator and control electronics, which are coupled or couplable to the electrode.

25. The system as claimed in claim 23, wherein the system comprises at least one further electrode as claimed in claim 1 and/or at least one further electrode known per se for medical application, the electrode being actively connected or actively connectable to the further electrode in such a way that a bipolar electrical supply can be set up.

26. A method for producing an electrode, wherein the lattice structure is produced at least partially by physical vapor deposition, a material being deposited layer-wise on a substrate and structured in such a way that a self-supporting lattice structure or a coated lattice-like carrier structure is formed.

27. An electrode for medical applications for neuromodulation and/or nerve stimulation and/or neurological signal acquisition, which is compressible and expandable for introduction into a hollow organ (A) of a body and is coupled or couplable to an electrical supply, wherein the electrode comprises a compressible and expandable lattice structure which has cells formed by lattice webs and is coupled or couplable to the electrical supply, the lattice structure at least locally having at least two layers arranged successively in the radial direction.

28. The electrode as claimed in claim 27, wherein the layers arranged successively in the radial direction comprise a mechanically supporting layer, an insulator layer and an electrically conductive layer.

29. An electrode for medical applications for neuromodulation and/or nerve stimulation and/or neurological signal acquisition, which is compressible and expandable for introduction into a hollow organ of a body and is coupled or couplable to an electrical supply, wherein a compressible and expandable lattice structure which has cells formed by lattice webs and is coupled or couplable to the electrical supply, inclusions in the material of the lattice structure having a maximum size of 1 μm, or the material of the lattice structure being free of inclusions.
